(19) United States
(12) Patent Application Publication
(10) Pub. No.: US 2015/0326024 A1
(43) Pub. Date: Nov. 12, 2015

(54) Systems and Methods for Device and Power Receiver Pairing

(71) Applicant: Energous Corporation, Pleasanton, CA (US)

(72) Inventors: Douglas Bell, Pleasanton, CA (US); Michael Leabman, San Ramon, CA (US)

(21) Appl. No.: 14/272,093

(22) Filed: May 7, 2014

(51) Int. Cl. H02J 5/00

(52) U.S. Cl. CPC H02J 5/005

(57) ABSTRACT

Various exemplary embodiments of the present disclosure describe systems and methods for pairing electronic devices with wireless power receivers. The described systems include one or more wireless power transmitters, one or more wireless power receivers and one or more electronic devices. Electronic devices may be able to communicate with wireless power transmitters and wireless power receivers using suitable communications channels. The disclosed systems are capable of associating an electronic device with a wireless power receiver when the wireless power receiver is in close proximity or attached to the electronic device for a suitable period of time.

### CROSS-REFERENCE TO RELATED APPLICATIONS

N/A

### BACKGROUND

1. Field of the Disclosure

The present disclosure relates in general to wireless power transmission, and more specifically to pairing between devices and power receivers.

2. Background Information

Electronic devices such as laptop computers, smartphones, portable gaming devices and tablets, amongst others, may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Additionally, users may be required to plugin to a wall or other power supply to be able to charge his or her electronic device. However, such an activity may in some cases render electronic devices inoperable during charging.

For the foregoing reasons, there is a need for simple, reliable and user friendly wireless power transmission systems where electronic devices may be powered without requiring extra chargers or plugs, and where the mobility and portability of electronic devices may not be compromised.

### SUMMARY

The various exemplary embodiments presented here describe systems and methods for pairing electronic devices with wireless power receivers. The disclosed systems may include power transmitters, power receivers and electronic devices.

Power transmitters may be utilized for wireless power transmission using suitable techniques such as pocket-forming. Transmitters may be employed for sending Radio frequency (RF) signals to power receivers. Power receivers may be capable of converting RF signals into suitable electricity for powering and charging a plurality of electric devices. Wireless power transmission may allow powering and charging a plurality of electrical devices without wires.

To send power to a power receiver within the system, a power transmitter may identify in an internal database which power receiver is associated with which device.

When an electronic device detects that a power receiver is within a suitable range of proximity for a suitable amount of time, it may proceed to check an internal database to determine if the power receiver is not already paired with another electronic device. If the power receiver is not already paired with another device the electronic device may associate its ID with the ID of the power receiver and update the internal database. Then, the electronic device may send a copy of the updated database record to the power transmitter.

Numerous other aspects, features and benefits of the present disclosure may be made apparent from the following detailed description taken together with the drawings provided.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows a system architecture diagram, according an exemplary embodiment.

FIG. 2 is a flowchart of a charge request process, according to an exemplary embodiment.

FIG. 3 is a flowchart of a pairing process, according to an exemplary embodiment.

FIG. 4 is a flowchart of an unpairing process, according to an exemplary embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Pairing” refers to the association of a single electronic device with a single power receiver.

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

### Description of the Drawings

The various exemplary embodiments presented here describe systems and methods for pairing electronic devices with wireless power receivers.

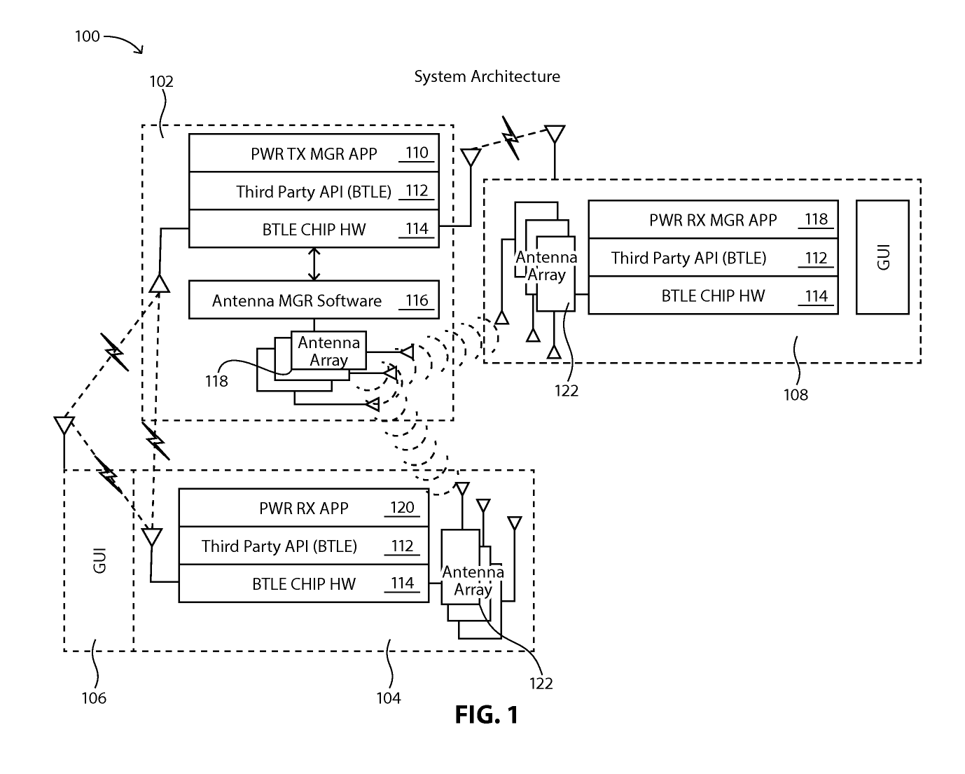

FIG. 1 shows a wireless charging system architecture 100, according to an exemplary embodiment. System architecture 100 may include one or more wireless power transmitters 102 , and one or more wireless power receivers 104. In some embodiments, wireless charging system architecture 100 may include one or more electronic devices 106, where electronic devices 106 may not have a built-in wireless power receiver 104. In other embodiments, wireless charging system architecture 100 may include electronic devices 108 with a built-in power receiver 104.

Power transmitters 102 may transmit controlled Radio Frequency (RF) waves which may converge in 3-D space. These RF waves may be controlled through phase and/or relative amplitude adjustments to form constructive and destructive interference patterns (pocket-forming). Pockets of energy may form at constructive interference patterns that may be 3-dimensional in shape whereas null-spaces may be generated at destructive interference patterns.

According to exemplary embodiments, power transmitters 102 may include a power transmitter manager application 110, a third party BTLE API 112, a BTLE chip 114, an antenna manager software 116 and an antenna array 118 among other components. Power transmitter manager application 110 may be an executable program loaded into a non-volatile memory within a power transmitter 102. Power transmitter manager application 110 may control the behavior of power transmitter 102, monitor the state of charge of electronic devices 106, electronic devices 108 and power receivers 104, may keep track of the location of power receivers 104 and may execute power schedules, amongst others. In some embodiments, power transmitters 102 may include a database (not shown in figure) for storing information related to power receivers 104, electronic devices 106, power status, power schedules, IDs, pairing and any suitable information necessary for running the system.

Third party BTLE API 112 may enable the effective interaction between power transmitter manager application 110 and BTLE chip 114. Antenna manager software 116 may process orders from power transmitter manager application 110 and may control antenna array 118.

Antenna arrays 118 that may be included in power transmitters 102 may include a number of antenna elements capable of transmitting power. In some embodiments, antenna array 118 may include from 64 to 256 antenna elements which may be distributed in an equally spaced grid. In one embodiment, antenna array 118 may have an 8×8 grid to have a total of 64 antenna elements. In another embodiment, antenna array 118 may have a 16×16 grid to have a total of 256 antenna elements. However, the number of antenna elements may vary in relation with the desired range and power transmission capacity of power transmitter 102. Generally, with more antenna elements, a wider range and higher power transmission capacity may be achieved. Alternate configurations may also be possible including circular patterns or polygon arrangements, amongst others.

The antenna elements of antenna array 118 may include suitable antenna types for operating in frequency bands such as 900 MHz, 2.5 GHz, 5.250 GHz, or 5.8 GHz, antenna elements may operate in independent frequencies, allowing a multichannel operation of pocket-forming.

Power transmitter 102 may additionally include other suitable communications methods such as Wi-Fi, Zig bee and LAN amongst others.

Power receivers 104 may include a power receiver application 120, a third party BTLE API 112, a BTLE chip 114, and an antenna array 122. Power receivers 104 may be capable of utilizing pockets of energy produced by power transmitter 102 for charging or powering electronic devices 106 and electronic devices 108. Power receiver application 120 may be an executable program loaded into a non-volatile memory within a power receiver 104.

Third party BTLE API 112 may enable the effective interaction between power receiver application 120 and BTLE chip 114. Antenna array 122 may be capable of harvesting power from pockets of energy.

Electronic devices 106 and electronic devices 108 may include a GUI for managing their interactions within wireless charging system architecture 100. The GUI may be associated with an executable program loaded into a non-volatile memory. In some embodiments, electronic devices 106 and electronic devices 108 may include a database (not shown in figure) for storing information related to power receivers 104, power status, power schedules, IDs, pairing and any suitable information necessary for running the system.

In some embodiments, wireless charging system architecture 100 may include multiple power transmitters 102 and/or multiple power receivers 104 for charging a plurality of electronic devices 106. In systems including multiple power transmitters 102, the two or more power transmitters may be in constant communication using any suitable communication channel available, including Bluetooth, BTLE, Wi-Fi, Zig bee, LAN, LTE and LTE direct amongst others.

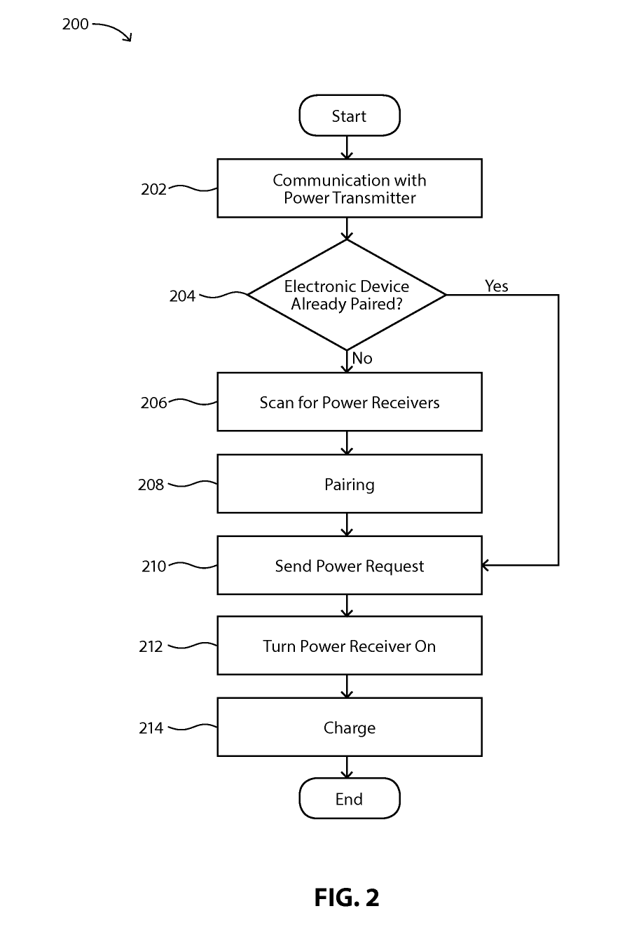

FIG. 2 is a flowchart of a charge request process 200, according to an exemplary embodiment. Process 200 may start when an electronic device, which includes a GUI suitable for interacting with a wireless charging system, communicates 202 with a power transmitter. During the communication the electronic device may send information to the power transmitter including device ID and charge status, amongst others. The power transmitter may update its database and may send a copy to the electronic device including the IDs of available power transmitters within the system.

Then, the electronic device may check 204 if its ID is already associated with the ID of a power receiver.

If the electronic device is not already paired, the electronic device may start scanning 206 for power receivers. All the power receivers in the system may broadcast advertisement messages at any time. The advertisement messages may include a unique 32 bit device ID and a system ID or UUID (Universally Unique Identifier). In some embodiments, the advertisement messages may include additional information. The electronic device may be capable of monitoring the signal strength of the ads being broadcasted by the different power receivers and keep track of the proximity of the power receivers to the electronic device.

When the electronic device detects that a power receiver is within a suitable range of proximity for a suitable amount of time, it may proceed to check the database to determine if the power receiver is not already paired with another electronic device. If the power receiver is not already paired with another device the electronic device may update the database with the association of electronic device's ID with the ID of the power receiver during pairing 208. Then, the electronic device may send a copy of the updated database to the power transmitter.

Once the electronic device is paired, a user, through the GUI in the electronic device, or the electronic may send a power request 210 to the power transmitter. If the power transmitter finds it suitable to provide power to the electronic device, it may turn on 212 the power receiver.

Afterwards, the power transmitter may aim the antenna array to the power receiver associated with the electronic device and start sending energy to the power receiver. The power receiver may then start charging 214 the electronic device. Once the electronic device is charged, the process may end.

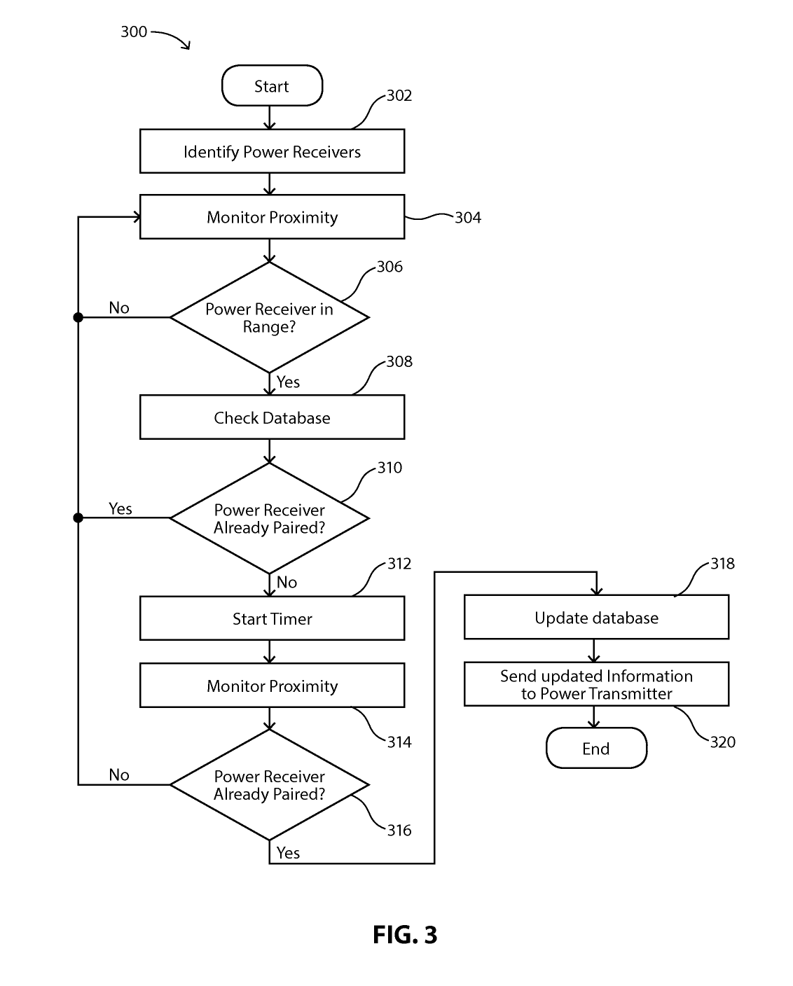

FIG. 3 is a flowchart of a pairing process 300, according to an exemplary embodiment. Pairing process 300 may start when an electronic device identifies 302 available power receivers in a system. Then, using the signal strength the electronic device may be capable of monitoring 304 the proximity of each of the available power receivers. The electronic device may constantly check 306 if one of the power receivers is within a suitable range of proximity to perform the pairing. If none of the power receivers is within the range, the electronic device may continue to monitor the proximity of the power receivers. If one of the power receivers is within range the electronic device may proceed to check the database 308 to determine if the power receiver is already paired 310. If the power receiver is associated with another electronic device, the electronic device may continue to scan for power receivers and track their proximity. If the power receiver has no associations, the electronic device may commence the pairing protocol, and may start 312 a timer and continuously monitor 314 the proximity of the power receiver. After a suitable time lapse the electronic device may check 316 if the power receiver is still within the suitable range. If the power receiver is not within the suitable proximity range the electronic device may continue to track the proximity of the power receivers. If the power receiver is still within a suitable proximity range the electronic device may update 318 the database, associating its ID with the ID of the power receiver.

In some embodiments, the GUI in the electronic device may analyze several signal strength measurements (RSSI) over the predetermined time lapse before updating the database. In some embodiments, the GUI may compute and average of the signal strength measurements and compare it with predefined reference values. After updating the information in an internal database, the electronic device may send 320 a copy of the updated database to the power transmitter and pairing process 300 may end.

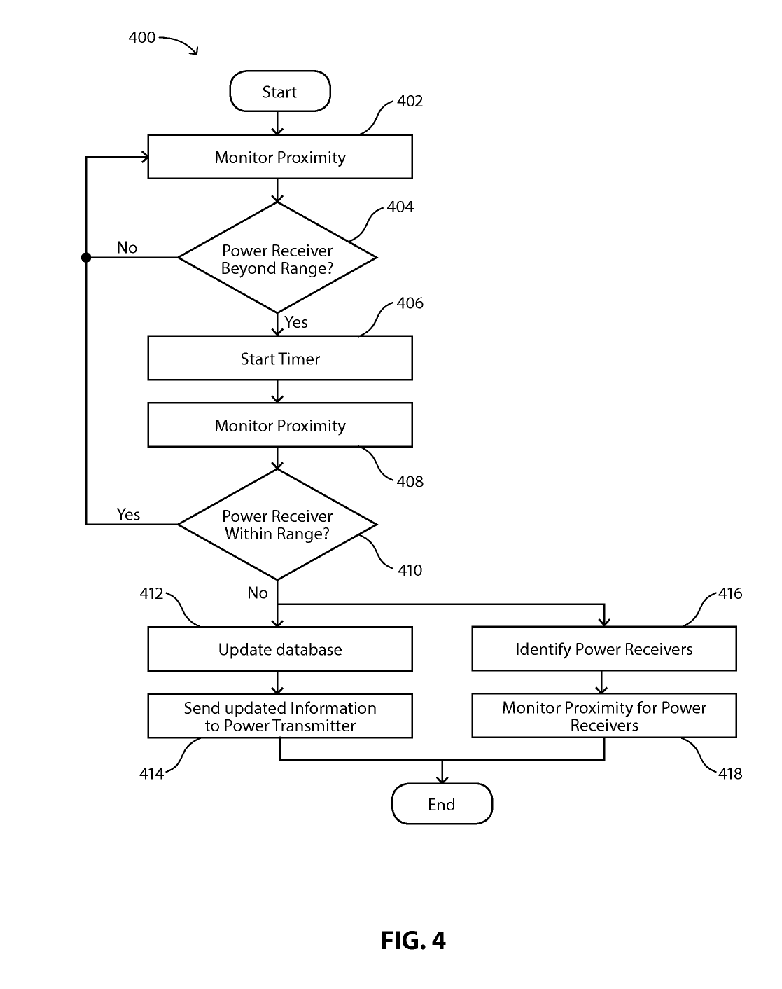

FIG. 4 is a flowchart of an unpairing process 400, according to an exemplary embodiment. Unpairing process 400 may start when an electronic device that is paired to a power receiver is constantly monitoring 402 the proximity of the power receiver to check 404 if the power receiver is beyond pairing range. If there is no change, the electronic device may continue to monitor 402 the proximity of the paired power receiver. If there is a change, the electronic device may start 406 a timer. After a suitable time lapse the electronic device may check 408 the signal strength of the ads broadcasted by the power receiver to determine 410 if the power receiver is still within a suitable range. This may be done by the GUI in the electronic device. The GUI may analyze several signal strength measurements (RSSI) over the predetermined time lapse. In some embodiments, the GUI may compute and average of the signal strength measurements and compare it with predefined reference values.

If the electronic device determines that the power receiver is still within the suitable proximity range it may continue to normally monitor the proximity of the power receiver. If the electronic device determines that the power receiver is not within the suitable proximity range any more the electronic device may proceed to update 412 the internal database and subsequently send 414 the updated version of the data base to the power transmitter. In a parallel process, the electronic device may start to scan and identify 416 available power receivers and continuously monitor 418 the proximity of the available power receivers and the unpairing process 400 may end.

### Examples

In example #1 a smartphone including a suitable GUI for interacting with a wireless charging system is paired with a power receiver embedded in a cellphone cover. At a first moment, the smartphone communicates with the power transmitter, is authenticated, receives the power receivers' database and starts scanning for power receiver devices. After scanning, the smartphone finds 3 available power receivers. It tracks the proximity of the power devices based on signal strength. At a second moment, one of the power receivers is placed near the smartphone. The smartphone determines that the power receiver is within the suitable range and starts the pairing process. After a few seconds it checks the signal strength again and it determines that the power receiver is still within an acceptable distance for pairing. Then, the smartphone updates its internal database and sends a copy of the updated database to the power transmitter. At a third moment, the smartphone sends a power request to the power transmitter. The power transmitter searches the database to determine which power receiver is associated with the smartphone, then it directs the antenna array towards the power receiver that is associated with the smartphone, and starts transmitting power.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for pairing a plurality of user devices and a plurality of transmitters in a wireless power network, comprising:
communicating through at least one user interface resident on ones of the user devices with at least one of the plurality of transmitters capable via provided controlled radio frequency waves that produce a plurality of energy pockets;
providing to a database associated with the at least one of a plurality of network transmitters information regarding the ones of the user devices; and
uniquely pairing the ones of the user devices with ones of the at least one of a plurality of network transmitters in accordance with the user device information and in order to receive, at the paired ones of the user devices, energy provided by the energy pockets.

2. The method of claim 1, wherein, user device information comprises at least one selected from the group consisting of a user device ID, current battery status, charge history information, proximity to the at least one transmitter, and combinations thereof.

3. The method of claim 1, further comprising providing at least one advertisement for display on the user device.

4. The method of claim 1, wherein the pairing of the user device with the at least one of a plurality of network transmitters is in accordance with the proximately of the user device to ones of the at least one of a plurality of network transmitters.

5. The method of claim 1, further comprising communicating a power request to ones of the at least one of a plurality of network transmitters.

6. The method of claim 1, wherein the user device comprises a power receiver identifiable by the at least one of a plurality of network transmitters.

7. The method of claim 1, wherein the pairing is effective after the user device has been in communication with the at least one of a plurality of network transmitters over a predetermined period of time.

8. The method of claim 7, wherein the predetermined period of time is set by the user.

9. The method of claim 7, wherein the predetermined period of time is greater than 5 seconds.

10. The method of claim 7, wherein the user device measures the signal strength of the at least one of a plurality of network transmitters during the predetermined period of time.

11. A system for pairing two devices in a wireless power network, comprising:
at least one user interface provided on a user device in communication with at least one of a plurality of network transmitters capable of providing controlled radio frequency waves to produce a plurality of energy pockets;
at least one database associated with the at least one of a plurality of network transmitters and information regarding the user device; and
at least one server for comparing the information comprising at least one user device identifier with at least one identifier of ones of the at least one of the plurality of network transmitters to facilitate pairing of the at least one user device and the at least one of a plurality of network transmitters.

12. The system of claim 11, wherein, user device information comprises at least one selected from the group consisting of a user device ID, current battery status, charge history information, proximity to the at least one transmitter, and combinations thereof.

13. The system of claim 11, further comprising at least one advertisement for display on the user device.

14. The system of claim 11, wherein the pairing of the user device with the at least one of a plurality of network transmitters is in accordance with the proximately of the user device to ones of the at least one of a plurality of network transmitters.

15. The system of claim 11, wherein the at least one user interface resident on a user device communicates a power request to ones of the at least one of a plurality of network transmitters.

16. The system of claim 11, wherein the user device comprises a power receiver identifiable by the at least one of a plurality of network transmitters.

17. The system of claim 11, wherein the at least one user interface resident on a user device pairs the user device with the at least one of a plurality of network transmitters after a predetermined period of time.

18. The system of claim 17, wherein the predetermined period of time is set by the user.

19. The system of claim 17, wherein the predetermined period of time is greater than 5 seconds.

20. The system of claim 17, wherein the user device measures the signal strength of the at least one of a plurality of network transmitters during the predetermined period of time.
